(19) United States
(12) Patent Application Publication
(10) Pub. No.: US 2018/0101718 A1
(43) Pub. Date: Apr. 12, 2018

(54) FINGERPRINT AUTHORISABLE DEVICE

(71) Applicant: Zwipe AS, Oslo (NO)

(72) Inventors: Peter Robert Lowe, Peyton, CO (US); Jose Ignacio Wintergerst Lavin, Colorado Springs, CO (US)

(21) Appl. No.: 15/290,081

(22) Filed: Oct. 11, 2016

(51) Int. Cl. G06K 9/00; G06F 21/62; G06Q 20/40; G06Q 20/34

(52) U.S. Cl. CPC G06K 9/00107; G06K 9/0002; G06K 9/00906; G06K 2009/00939; G06Q 20/40145; G06Q 20/34; G06F 21/6218

(57) ABSTRACT

A fingerprint authorisable device 102 comprising: a fingerprint sensor assembly 130 including a fingerprint sensor 26 and a conductive bezel 30; a control system 114, 128 for controlling the device 102 by providing access to one or more functions of the device 102 in response to identification of an authorised user; and an electrocardiograph electrode 142; wherein the electrocardiograph electrode 142 and the conductive bezel 30 of the fingerprint sensor assembly 130 are arranged for use as two electrodes for obtaining an electrocardiograph signal between two hands of the user; and wherein the control system 114, 128 is arranged to provide access to one or more functions of the device 102 based on fingerprint data from the fingerprint sensor 26 and/or based on the electrocardiograph signal.

### BACKGROUND TO THE INVENTION

The present invention relates to a fingerprint authorisable device and to a method for controlling a fingerprint authorisable device.

Fingerprint authorised devices such as smartcards are becoming increasingly more widely used. Smartcards for which biometric authorisation has been proposed include, for example, access cards, credit cards, debit cards, pre-pay cards, loyalty cards, identity cards, cryptographic cards, and so on. Smartcards are electronic cards with the ability to store data and to interact with the user and/or with outside devices, for example via contactless technologies such as RFID. These cards can interact with sensors to communicate information in order to enable access, to authorise transactions and so on. Other devices are also known that make use of biometric authorisation such as fingerprint authorisation, and these include computer memory devices, building access control devices, military technologies, vehicles and so on.

Although fingerprint biometrics provides enhanced security for the fingerprint protected device there is nonetheless still a need for further improvement. The type of situations where the user will wish for the added security of fingerprint protection are naturally also the type of situations where there is a greater risk of attacks that attempt to subvert that protection.

### SUMMARY OF THE INVENTION

Viewed from a first aspect the present invention provides a fingerprint authorisable device comprising:

a fingerprint sensor assembly including a fingerprint sensor and a conductive bezel;

a control system for controlling the device by providing access to one or more functions of the device in response to identification of an authorised user; and

an electrocardiograph electrode;

wherein the electrocardiograph electrode and the conductive bezel of the fingerprint sensor assembly are arranged for use as two electrodes for obtaining an electrocardiograph signal between two hands of the user; and

wherein the control system is arranged to provide access to one or more functions of the device based on fingerprint data from the fingerprint sensor and/or based on the electrocardiograph signal.

The presence of an electrocardiograph signal as well as a fingerprint sensor can boost the security of the device and/or allow it to be more widely used, for example as compared to a device with only fingerprint authorisation. Where a user can enroll a fingerprint then an electrocardiograph signal match may be required as well as a fingerprint match, thereby minimising the risk of a false finger being used, such as a fingerprint cast in silicone or wax that might otherwise fool the fingerprint sensor. An electrocardiograph signal can also ensure that a live finger is being presented to the device. If the owner of the finger is not alive, or the finger has been amputated, then the electrocardiograph signal will be incorrect and the authorisation attempt can hence be rejected. The control system may hence be arranged to prevent access to the one or more functions of the device when the electrocardiograph signal indicates that the finger is a false and/or non-living finger.

Moreover, an electrocardiograph signal can provide a biometric authorisation in its own right. Therefore it can provide an alternative form of identification of a user, for example if for some reason fingerprint enrolment is not possible due to damaged or missing fingers, and/or it can act as a back-up identification in the event that a user with enrolled fingerprint data suffers a temporary injury and/or their fingerprint becomes obscured. In the latter case the control system may optionally be arranged to provide lesser access to the one or more functions of the device for an electrocardiograph signal authorisation used in place of a fingerprint authorisation.

It should be noted that the use of an electrocardiograph signal for identification purposes is known in other devices and the current device can use any suitable system for matching of an enrolled electrocardiograph signal to a newly captured electrocardiograph signal and/or for analysis of an electrocardiograph signal to identify potentially fraudulent use of the device. Existing algorithms and matching criteria may be used. For example, US 2015/0373019 describes known systems and methods for electrocardiograph enrolment and authorisation. The proposed device differs significantly from other electrocardiograph sensors in that one of the electrodes is formed by the conductive bezel of the fingerprint sensor.

The conductive bezel may advantageously also be for providing an electrical field across the fingerprint sensor, for example in the case where a capacitive sensor is used. Thus, the conductive bezel may be electrically connected to the device such that it can act to provide an electrical field for the fingerprint sensor, for example an electrical field to provide the required capacitive effects or resistive effects for detecting the fingerprint features using an active capacitance sensor or a resistive sensor. By using the conductive bezel for this dual purpose the need for a second dedicated electrocardiograph electrode is avoided and the whole device can be more tightly packaged. This can be a significant advantage for many types of fingerprint authorisable device, which are often required to be small portable devices and where as a consequence space both within the device and at the outer surface(s) of the device is at a premium.

The conductive bezel may be any suitable conductive material, such as metal or a conductive plastic or ceramic material.

It will be understood that the device needs only the conductive bezel and the electrocardiograph electrode in order to make the necessary electrical connection across the two hands of a user to obtain an electrocardiograph signal. Thus, the device may include only one electrocardiograph electrode. There would typically also be only one conductive bezel, although it should be noted that some forms of fingerprint sensor assembly have a bezel that has multiple parts exposed around the area of the fingerprint sensor area, generally with a common electrical connection. The electrode and the conductive bezel may be exposed on surface of the device at locations to suit contact with one digit of each hand at each of the electrode and the conductive bezel. For example, in the case where the device is a smartcard then the electrode and the conductive bezel may be at opposite sides of the width or the length of one surface of the smartcard.

The electrocardiograph signal may, as noted above, be used as an alternative authentication method in the case that fingerprint authentication fails or is not possible. This may also apply in the case of a failure to enroll a fingerprint by the user. Thus, it is possible for users that are unable to enroll for fingerprint authorisation to still use some or all of the features of the device by means of a non-fingerprint authorisation using the electrocardiograph signal. Such a non-fingerprint authorisation also provides a way for enrolled users to continue to use the device when they are not able to provide fingerprint authorisation, for example due to an injury that prevents access to or damages the enrolled fingerprint(s). Further, some users may not wish to enroll via fingerprint, and this feature allows for those users to elect to use the device based purely on electrocardiograph authorisation, whilst at the same time still using the conductive bezel of the fingerprint sensor for interaction with the device during the authorisation process.

When electrocardiograph authorisation without fingerprint authorisation is used to access the one or more functions of the device, or alternatively/additionally when fingerprint authorisation without electrocardiograph authorisation is used to access the one or more functions of the device, then the user may be permitted access to all of the functions that are accessible via the other mode of authorisation or in the case of using both of electrocardiograph and fingerprint authorisation. Alternatively, the user may only be given restricted access to these functions.

In one possible implementation in the case of a failure to enroll, i.e. where there is no fingerprint data available for fingerprint authorisation, then the user may be permitted full access to the one or more functions of the device using the electrocardiograph authorisation. This then enables the device to be used fully by a person that is unable or unwilling to enroll a fingerprint, albeit with potentially reduced security.

Where there is enrolled fingerprint data but for some reason the user cannot complete the fingerprint authorisation process, e.g. in the case of an injury to the finger, then the device may be arranged to allow only partial access in response to the electrocardiograph authorisation. This can allow for restricted use of the device when a user who normally uses fingerprint authorisation or both mode of authorisation is temporarily unable to provide fingerprint authorisation or decides to use the electrocardiograph authorisation. For example, in the case where the device is a smartcard use for financial transactions then the use of electrocardiograph authorisation might permit payments with a limit on the size of the payments, whereas fingerprint authorisation may permit payments without limit or with a larger limit. Alternatively or additionally, the use of just one form of authorisation might permit lesser access, such as payments with a limit on the size of the payments, whereas the use of both forms of authorisation may permit greater access, such as payments without limit or with a larger limit.

The control system can include suitable processing routines and/or algorithms for controlling the level of access to the device dependent on the fingerprint data and the electrocardiograph signal, for example by reference to enrolled fingerprint data and/or earlier sampling of an electrocardiograph signal.

The fingerprint sensor assembly may comprise a suitable enclosure for holding the fingerprint sensor in place and for protecting the fingerprint sensor from bending and torsion in the case of a flexible device (such as a smartcard). There may optionally be a protective layer located on top of the sensor. This protective layer may be a scratch resistant material, such as a layer of a ceramic or glass material. The protective layer may comprise chemically toughened glass. One type of material that may be used as a protective layer is cover glass for mobile devices. A graded zirconia glass may be used. One possible material is alkali-aluminosilicate sheet glass, such as the glass sold under the trade name Gorilla Glass® and manufactured by Corning Inc. of New York, USA. It is preferred for both of the protective layer and the fingerprint sensor to be held by the same enclosure. In some examples the sensor is secured to the fingerprint authorisable device by the conductive bezel, which hence forms the enclosure or a part thereof. The protective layer, where present, may also be held to the device and to the sensor surface by the conductive bezel.

The shape of the conductive bezel may be complementary to the shape of the fingerprint sensor, and hence for example when the fingerprint sensor is rectangular then the conductive bezel is also of rectangular shape.

The fingerprint authorisable device may include an electronic circuit incorporating the fingerprint sensor and the control system. The electronic circuit may include a circuit board, and advantageously this may be a flexible printed circuit board. This allows the device to be flexible, for example to meet requirements such as ISO 7816 relating to smartcards. The fingerprint sensor may be mechanically attached to the circuit board and also electrically attached, advantageously using the same attachment mechanism for both the mechanical and the electrical attachment, for example by using surface mount technology, solder or conductive adhesive. The conductive bezel may be mechanically attached to the circuit board and also electrically attached, advantageously using the same attachment mechanism for both the mechanical and the electrical attachment, for example by using surface mount technology, solder or conductive adhesive. The fingerprint sensor and/or the conductive bezel may be attached to the circuit board via an inner casing. The inner casing may form a part of the enclosure as discussed above and/or may provide for mechanical and/or electrical coupling of the bezel to the circuit board.

In an advantageous example the fingerprint sensor assembly thus includes a two part enclosure for the fingerprint sensor. This two part enclosure may also hold the protective layer of scratch resistant material on top of the fingerprint sensor. The two part enclosure may comprise an inner casing for attachment to a circuit board of the fingerprint authorisable device and for enclosing the fingerprint sensor; and the conductive bezel, which is arranged for retaining the fingerprint sensor within the inner casing and is arranged to be coupled to the inner casing. The conductive bezel can advantageously also act as a conductive element to provide an electrical field for the fingerprint sensor as discussed above. The shape and other features of the conductive bezel in this two part enclosure may be as discussed above. The inner casing and/or the conductive bezel can act as a reinforcement member for protection of the fingerprint sensor as described below.

This arrangement has particular advantages where the fingerprint authorisable device is required to be flexible, for example in the case of an electronic card such as a smartcard, and hence the circuit board can be a flexible circuit board, such as a so called flexible printed circuit board assembly (FPCBA).

The inner casing and/or the conductive bezel of the two part enclosure may have a shape corresponding to the shape of the fingerprint sensor. Thus, in the common example of a rectangular fingerprint sensor the inner casing and/or the conductive bezel may have a rectangular shape. It is preferred for the inner casing and the conductive bezel to have a similar shape and to be arranged for complementary fit with one another. For example, the conductive bezel may be the same shape as the inner casing, but slightly larger so as to fit around the outside of the inner casing.

The inner casing may have side walls that extend away from the surface of the circuit board and at least partially enclose the fingerprint sensor and optionally the protective layer. The side walls may extend away from the surface of the circuit board a sufficient distance so that the top of the fingerprint sensor and/or the top of the protective layer are not exposed above the side walls. Preferably there is an opening in the side wall of the inner casing for allowing electrical connections between the circuit board and the fingerprint sensor. In the example of a rectangular inner casing the casing may have side walls about three sides of the rectangle with the fourth side of the rectangle having no side wall, or only a partial side wall. The inner casing may alternatively or additionally include conductive elements for making an electrical connection to the circuit board. This may be for connections to the fingerprint sensor and/or for an electrical connection to the conductive bezel.

The conductive bezel may enclose some or all of the outer periphery of the inner casing and preferably includes a side wall topped by a lip that extends across an outer rim of the exposed surface of the fingerprint sensor and/or protective layer. The conductive bezel may hence have a side wall extending from the lip toward the circuit board. An inner surface of the side wall of the conductive bezel preferably fits in close proximity to an outer surface of the side wall of the inner casing. Advantageously, the side wall of the conductive bezel may extend across the opening in the side wall of the inner casing, thereby ensuring that the fingerprint sensor is enclosed on all sides. The conductive bezel can be fitted after any required electrical connections are made through the opening in the side wall of the inner casing. In example embodiments the conductive bezel of the fingerprint sensor assembly extends around the entire outer periphery of the fingerprint sensor. The conductive bezel may have a side wall and/or lip that extends continuously around the entire periphery of the fingerprint sensor and/or protective layer.

The conductive bezel may be arranged to be coupled to the inner casing via any suitable connection. Preferably the connection is both mechanical and electrical, thereby securing the conductive bezel in place and allowing for it to be electrically coupled to the circuit board via the inner casing. The connection may be via an interference fit and/or through inter-coupling of resilient elements. For example, the connection may involve lugs on one of the two parts arranged to be received in recesses of the other of the two parts, where one or both parts is arranged to deform elastically during assembly to thereby provide a “snap-fit”. Other types of snap-fit connection may be used. The connection may alternatively or additionally use surface mount technology, solder and/or conductive adhesives.

The use of a two part enclosure in with a conductive bezel in combination with a further electrocardiograph electrode ensures that the fingerprint sensor can be protected from damage to its surface as well as protected from torsion/bending forces when the fingerprint authorisable device is in use and is bent or twisted, and further allows for the addition of extra security based on the electrocardiograph signal.

The conductive bezel may alternatively be formed in any suitable way, as is known for various fingerprint sensors in the prior art.

The fingerprint authorisable device may be an electronic card. The electronic card may comprise a card body having a cavity formed therein for the fingerprint sensor assembly; and an electronic circuit embedded within the card body, the electronic circuit preferably being a circuit board as discussed above. The circuit may include one or more contacts that are exposed by or accessible by the cavity. The cavity may be formed in an outer layer of the card body either before or after attachment of the outer layer to other components of the electronic card. One example electronic card includes a flexible circuit board, for example as described above; an upper card body layer; and a lower card body layer; wherein the upper and lower card body layers are laminated around and to the flexible circuit board to thereby assemble the electronic card. The upper and lower directions in this discussion are defined with respect to upper and lower surfaces of the flexible circuit board, with the upper surface being the surface to which the fingerprint sensor assembly is attached. Thus, the cavity may be in the upper card body layer.

The electronic card may include a cavity for the electrocardiograph electrode, which can be a cavity having similar features and/or being formed in a card body as the cavity for the fingerprint sensor, as explained above. Alternatively the electrocardiograph electrode may be placed on an upper surface of the card body, optionally in an indentation, and connected to an electrical conductive connection that extends through the card body, for example though the upper card body layer described above, and joins to the electronic circuit. The electrocardiograph electrode may include one or more printed or sputtered parts, for example the entirety of the electrode might be printed onto the surface of the card body.

The rear/lower face of the fingerprint sensor assembly may be in contact with and/or bonded to the circuit board. For example, it may include a thin layer of adhesive such as an epoxy or the like bonding the base of the sensor assembly to the circuit board.

One or more additional electronic components may also be embedded within the card body and connected to the circuit for processing biometric data received from the biometric sensor. The card body may be formed integrally about the embedded components, for example by lamination.

In example embodiments, the electronic components include a memory and processor connected to the circuit, the memory being for storing reference fingerprint data and the processor being configured to compare biometric fingerprint data received from the sensor with the stored reference data and/or configured to process the. The processor may be a part of the control system.

The circuit may include an antenna for wireless communication with a card reader, for example using RF communication. Thus, the card may be an RFID card. The card may or may not include a battery for powering the RF communication.

In various embodiments, the card body is formed from plastic such as PVC or PE. Thus, the upper card body layer and lower card body layer mentioned above may be PVC or PE. PVC is most commonly used.

The card may further comprise a reinforcement member configured to protect the fingerprint sensor assembly, preferably against bending moments. The reinforcement member may also act as the conductive bezel. The fingerprint sensor is relatively weak compared to the main body of the card, and bending in particular can damage a fingerprint sensor. The addition of a reinforcement member, advantageously one that also forms a bezel as described above, can reduce the risk of damage to the sensor when bending by increasing the stiffness of the card at the location of the fingerprint sensor assembly, and hence reducing the bending forces applied to the sensor.

The reinforcement member is preferably made of metal, such as steel (e.g. stainless steel) or copper. Metal has much higher resistance to bending than typical materials used to make such cards, e.g. PVC or other plastics materials.

Where the fingerprint sensor is an active capacitance fingerprint sensor, the reinforcement member may be configured to operate as an electrode of the sensor. For example, the reinforcement member may comprise a conductive surface on the front face of the card for contact with the finger. Again this functionality may be combined with use of the conductive bezel as the reinforcement member. Compared to normal electrodes, the reinforcement member may be thicker in cross-section, or may surround a greater amount of the sensor in order to provide the reinforcement effect. In preferred embodiments, the reinforcement member completely surrounds the fingerprint sensor.

The reinforcement member may comprise a planar portion adjacent a front face of the fingerprint sensor assembly and surrounding adjacent a sensing area of the fingerprint sensor assembly. The planar portion may form a rectangular plate, and in one configuration has a central hole for the sensing area to be exposed, for example a rectangular hole.

The reinforcement member may comprise an edge portion adjacent the sides of the fingerprint sensor assembly and the transition member. The edge portion may form a closed shape around all sides of the fingerprint sensor assembly and transition member. For example, a tubular, rectangular shape.

In one embodiment the reinforcement member comprises both the planar portion and the edge portion, with the edge portion extending away from the plane of the planar portion. These portions may be integrally connected such that the reinforcement member has an open, box-like structure.

The reinforcement member, in one example takes the form of an open frame with one or more sides of the frame having an inverted, L-shape section (i.e. with the bottom of the L-shape at the front of the card), preferably with the planar portion forming a horizontal of the inverted L-shape and the edge portion forming a vertical of the inverted L-shape. This shape has been found to be highly effective at protecting the biometric sensor and transition member against damage.

The thickness of the, or each, of the planar portion and/or the edge portion may be at least 0.05 mm.

The fingerprint authorisable device may be a smartcard such as any of: an access card; a credit card; a debit card; a pre-pay card; a loyalty card; an identity card; and a cryptographic card. The smartcard is preferably arranged to be inoperable if the fingerprint sensor and/or the electrocardiograph signal does not provide an indication of an authorised user.

The authorised user may initially enroll their fingerprint as well as a sample electrocardiograph with the device, optionally indirectly through some other device, but preferably directly onto the device via the fingerprint sensor assembly and the electrocardiograph electrode. The user may then typically be required to place their finger or thumb on the fingerprint sensor in order to authorise some or all uses of the device and/or place one digit of each hand on each of the electrocardiograph electrode and the conductive bezel in order for an electrocardiograph signal to be provided. A fingerprint matching algorithm in the control system may be used to identify a fingerprint match between an enrolled user and a fingerprint sensed by the fingerprint sensor. An electrocardiograph analysis algorithm in the control system may be used to check for a false finger and/or to biometrically identify the user based on the electrocardiograph signal.

It is preferred for the device to be arranged so that it is impossible to extract the data used for identifying users via fingerprint and/or non-fingerprint authorisation, example by a fingerprint template or the like. The transmission of this type of data outside of the device is considered to be one of the biggest risks to the security of the device.

To avoid any need for communication of the fingerprint and/or electrocardiograph data outside of the device then the device may be able to self-enroll, i.e. the control system may be arranged to enroll an authorised user by obtaining fingerprint data via the fingerprint sensor and by obtaining electrocardiograph data via the electrocardiograph electrode/conductive bezel. This also has advantages arising from the fact that the same sensor/electrodes with the same geometry are used for the enrolment as for the later authorisation. The data can be obtained more consistently in this way compared to the case where a different sensor/different electrode on a different device is used for enrolment. With fingerprint biometrics, one problem has been that it is difficult to obtain repeatable results when the initial enrolment takes place in one place, such as a dedicated enrolment terminal, and the subsequent enrolment for matching takes place in another, such as the terminal where the matching is required. The mechanical features of the housing around each fingerprint sensor must be carefully designed to guide the finger in a consistent manner each time it is read by any one of multiple sensors. If a fingerprint is scanned with a number of different terminals, each one being slightly different, then errors can occur in the reading of the fingerprint. Conversely, if the same fingerprint sensor is used every time then the likelihood of such errors occurring is reduced. Similar issues apply with the electrocardiograph signal.

In accordance with the proposed device, both the matching and enrolment scans may be performed using the same fingerprint sensor assembly and electrocardiograph electrode. As a result, fingerprint scanning errors can be balanced out because, for example, if a user tends to present their finger with a lateral bias during enrolment, then they are likely to do so also during matching. This self-enrolment also means that any effect on the fingerprint data and/or the electrocardiograph signal from the geometry of the device and the locations of the sensor assembly/electrode will be present in both the enrolled data and the data used for authentication.

The control system may have an enrolment mode in which a user may enroll their fingerprint and/or an electrocardiograph signal, with the data generated during enrolment being stored on the memory. The control system may be arranged to prompt the user for enrolment of a non-fingerprint authorisation code in addition to fingerprint enrolment (i.e. to allow for later failures in fingerprint authorisation) and/or in the event of a failure to enroll the user. The control system may be arranged to insist upon enrolment by at least one of fingerprint or electrocardiograph data.

The control system may be in the enrolment mode when the device is first provided to the user, so that the user can immediately enroll. The first enrolled user may be provided with the ability to later prompt an enrolment mode for subsequent users to be added, for example via input on an input device of the device after identification has been confirmed. Alternatively or additionally it may be possible to prompt the enrolment mode of the control system via outside means, such as via interaction between the device and a secure system, which may be a secure system controlled by the manufacturer or by another authorised entity.

The control system may include a fingerprint processor for executing a fingerprint matching algorithm and a memory for storing fingerprint data for enrolled fingerprints. The control system of the device may include multiple processors, wherein the fingerprint processor may be a separate processor associated with the fingerprint sensor. Other processors may include a dedicated processor or sub-processor for processing the electrocardiograph signal, a control processor for controlling basic functions of the device, such as communication with other devices (e.g. via contactless technologies), activation and control of receivers/transmitters, activation and control of secure elements such as for financial transactions and so on. The same processor may be used for the electrocardiograph signal and for the fingerprint matching algorithm. The various processors could be embodied in separate hardware elements, or could be combined into a single hardware element, possibly with separate software modules.

The fingerprint authorisable device may be a portable device, by which is meant a device designed for being carried by a person, preferably a device small and light enough to be carried conveniently. The device can be arranged to be carried within a pocket, handbag or purse, for example. The device may be a smartcard such as a fingerprint authorisable RFID card. The device may be a control token for controlling access to a system external to the control token, such as a one-time-password device for access to a computer system or a fob for a vehicle keyless entry system. The device is preferably also portable in the sense that it does not rely on a wired power source. The device may be powered by an internal battery and/or by power harvested contactlessly from a reader or the like, for example from an RFID reader.

The device may be a single-purpose device, i.e. a device for interacting with a single external system or network or for interacting with a single type of external system or network, wherein the device does not have any other purpose. Thus, the device is to be distinguished from complex and multi-function devices such as smartphones and the like.

Where the device is a smartcard then as discussed above the smartcard may be any of: an access card, a credit card, a debit card, a pre-pay card, a loyalty card, an identity card, a cryptographic card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where the device is a control token it may for example be a keyless entry key for a vehicle, in which case the external system may be the locking/access system of the vehicle and/or the ignition system. The external system may more broadly be a control system of the vehicle. The control token may act as a master key or smart key, with the radio frequency signal giving access to the vehicle features only being transmitted in response to fingerprint and/or electrocardiograph identification of an authorised user. Alternatively the control token may act as a remote locking type key, with the signal for unlocking the vehicle only being able to be sent if the fingerprint authorisation module identifies an authorised user. In this case the identification of the authorised user may have the same effect as pressing the unlock button on prior art keyless entry type devices, and the signal for unlocking the vehicle may be sent automatically upon identification of an authorised user, or sent in response to a button press when the control token has been previously activated by authentication of an authorised user.

The device may be capable of wireless communication, such as using RFID or NFC communication. Alternatively or additionally the device may comprise a contact connection, for example via a contact pad or the like such as those used for “chip and pin” payment cards. In various embodiments, the device may permit both wireless communication and contact communication.

The present invention also provides, in a second aspect, a method of controlling a fingerprint authorisable device comprising: a fingerprint sensor assembly including a fingerprint sensor and a conductive bezel; a control system for controlling the device; and an electrocardiograph electrode; the method including: one or both of using the electrocardiograph electrode and the conductive bezel of the fingerprint sensor assembly as two electrodes for obtaining an electrocardiograph signal between two hands of the user, and using the fingerprint sensor for obtaining fingerprint data from the user; and providing access to one or more functions of the device based on the fingerprint data from the fingerprint sensor and/or based on the electrocardiograph signal.

This method can provide increased security and/or increased utility for the device. The method may include using any of the features discussed above in connection with the first aspect. Where a user can enroll a fingerprint then an electrocardiograph signal match may be required as well as a fingerprint match. The method may include determining if the owner of the finger is not alive, or the finger has been amputated based on the electrocardiograph signal and rejecting the authorisation attempt when the electrocardiograph signal indicates that the finger is a false and/or a non-living finger.

If for some reason fingerprint enrolment is not possible, for example due to damaged or missing fingers or a user with enrolled fingerprint data suffers a temporary injury and/or their fingerprint becomes obscured then the method may include using authorisation via the electrocardiograph signal as a substitute for fingerprint authorisation. This authorisation may provide lesser access to the one or more functions of the device for an electrocardiograph signal authorisation used in place of a fingerprint authorisation.

The method may include providing an electrical field for the fingerprint sensor using the conductive bezel.

When electrocardiograph authorisation without fingerprint authorisation is used to access the one or more functions of the device, or alternatively/additionally when fingerprint authorisation without electrocardiograph authorisation is used to access the one or more functions of the device, then the user may be permitted access to all of the functions that are accessible via the other mode of authorisation or in the case of using both of electrocardiograph and fingerprint authorisation. Alternatively, the user may only be given restricted access to these functions. The access may be controlled as discussed above.

In a further aspect, a method of manufacturing a fingerprint authorisable device comprises: providing a control system for controlling the device, wherein the control system is arranged to provide access to one or more functions of the device in response to identification of an authorised user; providing a fingerprint sensor assembly including a fingerprint sensor for obtaining fingerprint data; providing the fingerprint sensor assembly with a conductive bezel; and providing an electrocardiograph electrode on the device; wherein the conductive bezel and the electrocardiograph electrode are for obtaining an electrocardiograph signal from between two hands of a user; and wherein the control system is arranged to provide access to one or more functions of the device based on the fingerprint data from the fingerprint sensor and/or based on the electrocardiograph signal.

This method may include providing any of the features of the device as discussed above in connection with the first aspect. Thus, the fingerprint authorisable device may be an electronic card and the method may include providing the electrocardiograph electrode along with the fingerprint sensor assembly in a card body of the electronic card. The card body may be formed with a cavity for receiving the fingerprint sensor assembly. An electronic circuit may be embedded within the card body, the electronic circuit preferably being a circuit board as discussed above. The cavity may be formed in an outer layer of the card body either before or after attachment of the outer layer to other components of the electronic card. The electronic card may include a cavity for the electrocardiograph electrode, which can be a cavity having similar features and/or being formed in a card body as the cavity for the fingerprint sensor, as explained above. Alternatively the electrocardiograph electrode may be placed on an upper surface of the card body, optionally in an indentation, and connected to an electrical conductive connection that extends through the card body, for example though the upper card body layer described above, and joins to the electronic circuit.

The method may comprise providing the fingerprint sensor assembly with a protective layer located on top of a sensing surface of the fingerprint sensor, the protective layer comprising a scratch resistant material.

The fingerprint sensor may be held on a circuit board by an enclosure as described above, where the conductive bezel may form the enclosure or a part thereof. The conductive bezel may advantageously be provided as a conductive element of the fingerprint sensor assembly as a part of an active capacitance sensor.

In an advantageous example the fingerprint sensor assembly includes a two part enclosure for the fingerprint sensor and the protective layer. The method may include attaching an inner casing of the two part enclosure to a circuit board of the fingerprint authorisable device, the inner casing being for enclosing the fingerprint sensor. The fingerprint sensor may be inserted into the inner casing after attachment of the inner casing to the circuit board, with the protective layer optionally being provided on top of the fingerprint sensor.

The two part enclosure may include coupling the conductive bezel to the inner casing and retaining the fingerprint sensor within the inner casing using the conductive bezel. The conductive bezel can advantageously act as a conductive element to provide an electrical field for the fingerprint sensor as discussed above. The shape and other features of the inner casing and/or conductive bezel in the method may be as discussed above.

The method may include electrically connecting the fingerprint sensor to the circuit board, and this may be done via electrically conductive parts of the inner casing and/or via electrical connections passing through an opening in a side wall of the inner casing as discussed above. The inner casing may have electrically conductive parts and the method can include using the inner casing to provide electrical connections to the fingerprint sensor and/or the conductive bezel.

The step of coupling the conductive bezel to the inner casing may be carried out after any required electrical connections are made, for example through the opening in the side wall of the inner casing. The coupling of the conductive bezel to the inner casing may involve the use of an interference fit and/or inter-coupling of resilient elements. The connection may involve using lugs and recesses as described above.

### LIST OF FIGURES

Certain preferred embodiments on the present invention will now be described in greater detail, by way of example only and with reference to the accompanying drawings, in which:

FIG. 1 illustrates a circuit for a smartcard with a fingerprint sensor and an electrocardiograph electrode;

FIG. 2 illustrates a first example of the smartcard including an external housing;

FIG. 3 illustrates a second example of the smartcard, which is a laminated card;

FIG. 4 shows a schematic plan view of an inner casing of a fingerprint sensor assembly;

FIG. 5 shows the inner casing of FIG. 4 in side/cross-section view;

FIG. 6 shows a side/sectional schematic view of a circuit board fitted with the inner casing and ready to receive a fingerprint sensor;

FIG. 7 shows a plan view of a conductive bezel for fitting to the inner casing;

FIG. 8 shows a side/section view of the conductive bezel of FIG. 7;

FIG. 9 shows the circuit board of FIG. 6 and fitting of the conductive bezel to the inner casing;

FIG. 10 shows the side/sectional view of the circuit board of FIG. 6 with the conductive bezel fitted to the inner casing;

FIG. 11 shows a schematic plan view of the circuit board of FIG. 10;

FIG. 12 illustrates another arrangement for a smartcard with a fingerprint sensor and an electrocardiograph electrode.

### DESCRIPTION OF EXAMPLE EMBODIMENTS

By way of example the invention is described in the context of a fingerprint authorised smartcard that includes contactless technology and uses power harvested from the sensor. These features are envisaged to be advantageous features of one application of the proposed fingerprint failure feature, but are not seen as essential features. The smartcard may hence alternatively use a physical contact and/or include a battery providing internal power, for example. The fingerprint sensor assembly 130 described herein can also be implemented with appropriate modifications in any other device or system that uses a fingerprint sensor for fingerprint authorisation.

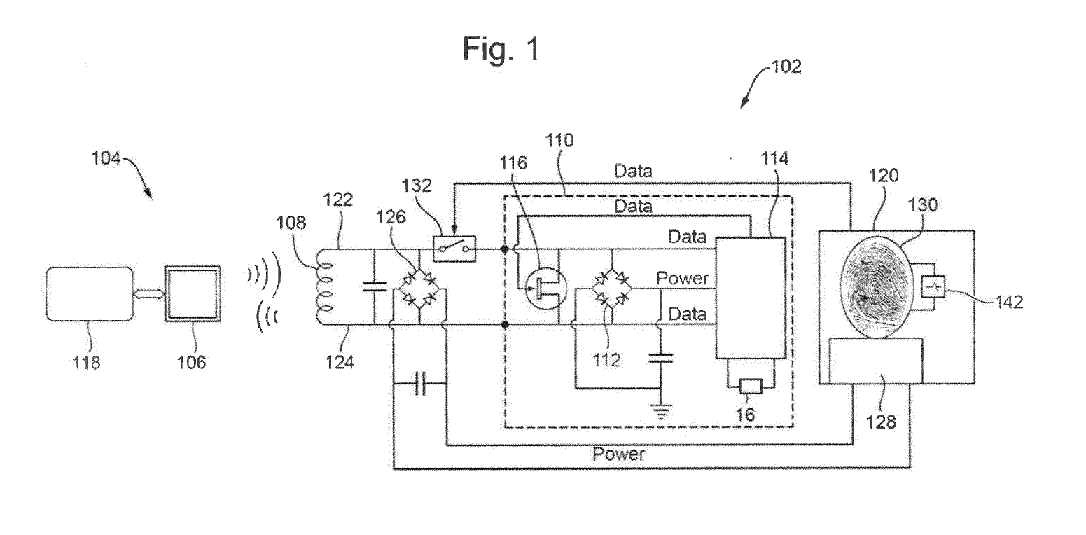

FIG. 1 shows the architecture of a smartcard 102 that is provided with the fingerprint sensor assembly 130. A powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the sensor 104. This type of signalling is known as backscatter modulation and is characterised by the fact that the sensor 104 is used to power the return message to itself.

An accelerometer 16, which is an optional feature, is connected in an appropriate way to the processor 114. The accelerometer 16 can be a Tri-axis Digital Accelerometer as provided by Kionix, Inc. of Ithaca, N.Y., USA and in this example it is the Kionix KXCJB-1041 accelerometer. The accelerometer senses movements of the card and provides an output signal to the processor 114, which is arranged to detect and identify movements that are associated with required operating modes on the card as discussed below. The accelerometer 16 may be used only when power is being harvested from the powered card reader 104, or alternatively the smartcard 102 may be additionally provided with a battery (not shown in the Figures) allowing for the accelerometer 16, and also the related functionalities of the processor 114 and other features of the device to be used at any time.

The smartcard further includes a fingerprint authentication engine 120 including a fingerprint processor 128 and a fingerprint sensor assembly 130. This allows for enrolment and authorisation via fingerprint identification. The fingerprint authentication engine further includes an electrocardiograph electrode 142, which is used together with a conductive bezel 30 of the fingerprint sensor assembly 130 to provide an electrocardiograph signal measured between two hands of the user. The conductive bezel 30 is as described below in an example embodiment. The fingerprint processor 128 (or optionally the processor 114 or a further processor) also performs an electrocardiograph authorisation process. The fingerprint processor 128 and the processor 114 that controls the communication chip 110 together form a control system for the device. The two processors 128, 114 could in fact be implemented as software modules on the same hardware, although separate hardware could also be used. As with the accelerometer 16 (where present) the fingerprint sensor assembly 130 and the fingerprint authentication engine 120 may be used only when power is being harvested from the powered card reader 104, or alternatively the smartcard 102 may be additionally provided with a battery (not shown) allowing power to be provided at any time for the fingerprint authentication engine 120, as well as the processor 114 and other features of the device.

The antenna 108 comprises a tuned circuit including an induction coil and a capacitor, which are tuned to receive an RF signal from the card reader 104. When exposed to the excitation field generated by the sensor 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and then supplied to the fingerprint authentication engine 120 and other electrical components. Alternatively or additionally a battery may be included as noted above.

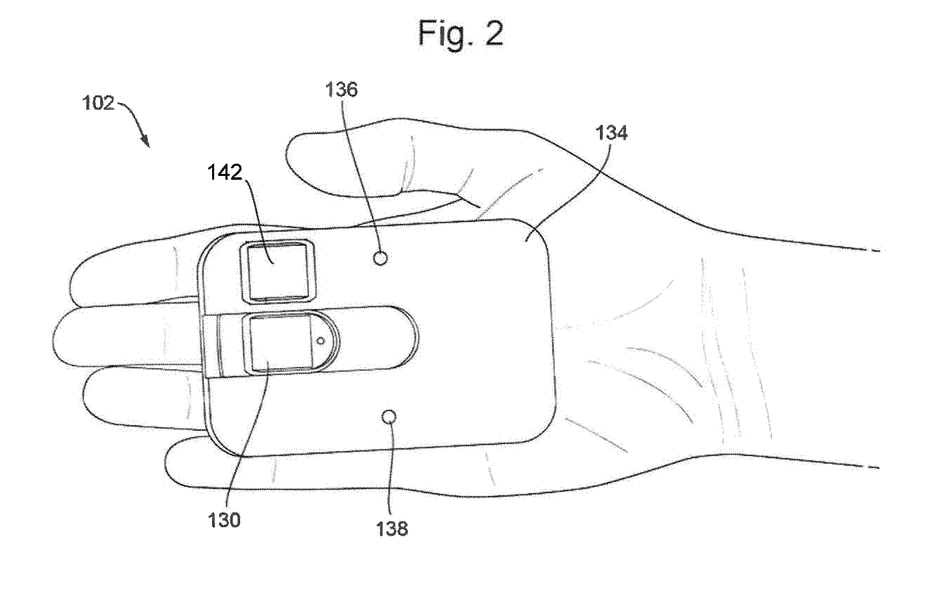

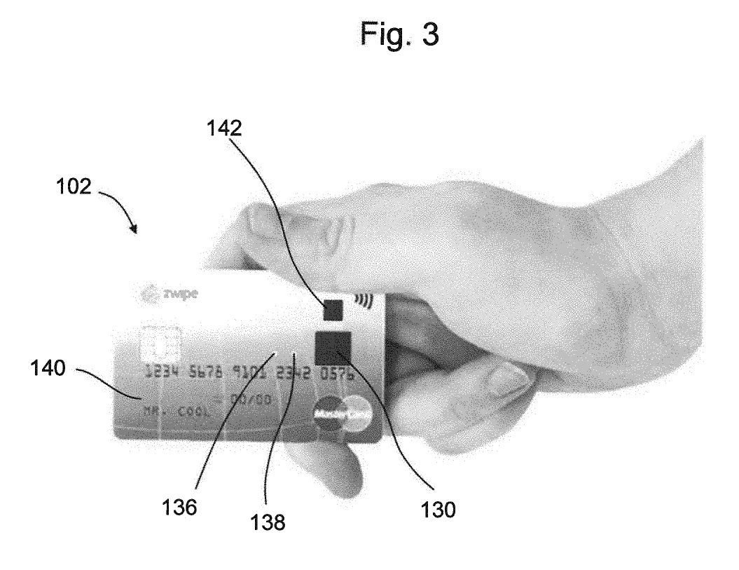

The fingerprint sensor assembly 130, which is described in more detail below with reference to FIGS. 4 to 11, may be mounted on a card housing 134 as shown in FIG. 2 or fitted so as to be exposed from a laminated card body 140 as shown in FIG. 3 or FIG. 12. The electrocardiograph electrode 142 is likewise mounted on the card housing 134 or exposed from the laminated card body 140. The electrocardiograph electrode 142 can be a simple conductive element such as a metal plate. The positioning of the electrocardiograph electrode 142 and the fingerprint sensor assembly 130 is such that the user can easily touch a digit from each hand to the electrocardiograph electrode 142 and the fingerprint sensor assembly 130 respectively. This can be using spaced apart locations as in FIG. 12, or it may use closer spacing as shown in FIGS. 2 and 3. The locations of the electrocardiograph electrode 142 and the fingerprint sensor assembly 130 may be set in order to fit the various parts around other elements of the device that have restrictions on their location. For example, in the case of a smartcard that can be used as a bank card there are requirements for specific locations for features such as the contact pad for ‘chip and pin’ transactions, and certain areas of the card are typically reserved for branding.

The card housing 134 or the laminated body 140 encase all of the components of FIG. 1, and is sized similarly to conventional smartcards.

The fingerprint authentication engine 120 may be passive, and hence may be powered only by the voltage output from the antenna 108. Alternatively, and as noted above, a battery (not shown) may be provided for powering the fingerprint authorisation engine 120. The processor 128 is a microprocessor that is chosen to be of very low power and very high speed, so as to be able to perform fingerprint matching in a reasonable time.

The fingerprint authentication engine 120 is arranged to scan a finger or thumb presented to the fingerprint sensor assembly 130 and to compare the scanned fingerprint of the finger or thumb to pre-stored fingerprint data using the processor 128. A determination is then made as to whether the scanned fingerprint matches the pre-stored fingerprint data. In a preferred embodiment, the time required for capturing a fingerprint image and authenticating the bearer of the card 102 is less than one second. The user may also be required to go through an electrocardiograph identity check at the same time or separately. In this case as well as placing a digit on the fingerprint sensor assembly 130 the user also puts a digit of the other hand in contact with the electrocardiograph electrode 142, for example as shown in FIG. 12. An electrocardiograph signal is obtained by measurements between the two hands of the user by means of the electrocardiograph electrode 142 and the conductive bezel 30 of the fingerprint sensor assembly 130. A determination is then made as to whether the electrocardiograph signal is consistent with set parameters indicative of a living and/or unmodified fingerprint (i.e. without a false fingerprint in silicone or the like) and/or if the electrocardiograph signal is consistent with a reference electrocardiograph signal provided by the user upon enrolment with the device 102.

If a fingerprint match and/or electrocardiograph signal match is determined then the processor takes appropriate action depending on its programming. In this example the authorisation process may be used to authorise the use of the smartcard 104 with the contactless card reader 104. Thus, the communication chip 110 is authorised to transmit a signal to the card reader 104 when a fingerprint match is made. The communication chip 110 transmits the signal by backscatter modulation, in the same manner as the conventional communication chip 110. The card may provide an indication of successful authorisation using a suitable indicator, such as a first LED 136.

In some circumstances, the owner of the fingerprint smartcard 102 may suffer an injury resulting in damage to the finger that has been enrolled on the card 102. This damage might, for example, be a scar on the part of the finger that is being evaluated. Such damage can mean that the owner may not be authorised by the card 102 since a fingerprint match is not made. In this event the processor 114 may prompt the user for a back-up identification/authorisation check via an alternative interaction with the smartcard 102, which in this case includes one or more action(s) detected via the fingerprint sensor assembly 130, such as for example the electrocardiograph signal, and also optionally may include actions detected via other sensors, such as the accelerometer 16. The card may prompt the user to present a back-up identification/authorisation using a suitable indicator, such as a second LED 138. Such a non-fingerprint authorisation might require a sequence of interactions with the card by the user, this sequence being pre-set by the user. The pre-set sequence for non-fingerprint authorisation may be set when the user enrolls with the card 102. The user can hence have a non-fingerprint authorisation in the form of a “password” entered using non-fingerprint interactions with the card to be used in the event that the fingerprint authorisation fails. The same type of non-fingerprint authorisation can be used in the event that a user is unable or unwilling to enroll with the card 102 via the fingerprint sensor assembly 130.

Thus, as well as allowing communication via the circuit 110 with the card reader 104 in response to a fingerprint authorisation via the fingerprint sensor assembly 130 and fingerprint processor 128 the processor 114 may also be arranged to allow such communication in response to a non-fingerprint authorisation.

When a non-fingerprint authorisation is used the card 102 could be arranged to be used as normal, or it could be provided with a degraded mode in which fewer operating modes or fewer features of the card 102 are enabled. For example, if the smartcard 102 can act as a bank card then the non-fingerprint authorisation might allow for transactions with a maximum spending limit lower than the usual maximum limit for the card 102.

When the optional accelerometer 16 is present then the processor 114 receives the output from the accelerometer 16 and this allows the processor 114 to determine what movements of the smartcard 102 have been made. The processor 114 identifies pre-set movements and other actions of the user that are linked with required changes to the operating mode of the smartcard. The movements may include any type of or combination of rotation, translation, acceleration, impulse and other movements detectable by the accelerometer 16. The other actions of the user may include actions detected via the fingerprint sensor, such as taps, swipes and so on.

The operating modes that the processor 114 activates or switches to in response to an identified movement associated with the required change in operating mode may include any mode of operation, including turning the card on or off, activating secure aspects of the card 102 such as contactless payment, or changing the basic functionality of the card 102 for example by switching between operating as an access card, a payment card, a transportation smartcard, switching between different accounts of the same type (e.g. two bank accounts), switching between communications protocols (such as blue tooth, wifi, NFC) and/or activating a communication protocol, activating a display such as an LCD or LED display, obtaining an output from the smartcard 102, such as a one-time-password or the like, or prompting the card 102 to automatically perform a standard operation of the smartcard 102.

The processor 114 has an enrolment mode, which may be activated upon first use of the smartcard 102. In the enrolment mode the user is prompted to enroll their fingerprint data via the fingerprint sensor assembly 130. This can require a repeated scan of the fingerprint via the fingerprint sensor assembly 130 so that the fingerprint processor 128 can build up appropriate fingerprint data, such as a fingerprint template. After a successful or an unsuccessful enrolment of fingerprint data the user is prompted to enter a non-fingerprint authorisation. This could be optional in the case of a successful fingerprint enrolment, or compulsory if the fingerprint enrolment was not successful. The non-fingerprint authorisation includes a sequence of interactions with the smartcard 102 including at least one action by the user that is detected via the fingerprint sensor assembly 130. The processor 114 can keep a record of these interactions in a memory, and it is arranged to provide at least partial authorisation to use the functions of the card in the event that the non-fingerprint authorisation is provided by the user.

The processor 114 can have a learn mode to allow for the user to specify which actions (including combinations of actions/interactions) should activate particular operating modes whilst the smartcard 102 is in use. This type of control of the smartcard 102 might be enabled only after a successful fingerprint or non-fingerprint authorisation. In the learn mode the processor 114 prompts the user to make the desired sequence of actions, and to repeat the movements for a predetermined set of times. These movements are then allocated to the required operating mode or to the non-fingerprint authorisation. With this latter feature the learn mode can allow for the sequence of movements used for the non-fingerprint authorisation to be changed by the user in the same way that a traditional PIN can be changed.

An example arrangement for the fingerprint sensor assembly 130 will now be described with reference to FIGS. 4 to 11. It should be noted that for the sake of clarity the figures are shown in schematic form only with exaggerated scale. It will be appreciated that the actual sizes of the various parts, in particular their heights, are much less that shown and that the parts would fit together more closely than indicated in the drawings.

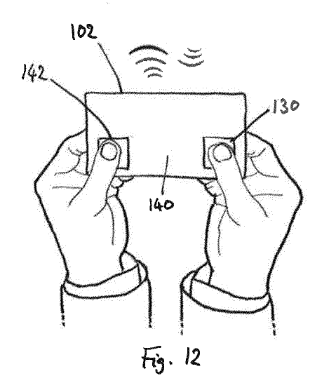

The completed fingerprint sensor assembly 130 mounted on a circuit board, which in this example is a flexible printed circuit board assembly 24, is shown schematically inside/section view in FIG. 10 and in plan view in FIG. 11. The fingerprint sensor assembly includes an inner casing 20 which is shown in plan view in FIG. 4 and in cross-section view in FIG. 5 the inner casing is three sided as can be seen in FIG. 4 and also in FIG. 11. Since one side 21 of the inner casing 20 is left open then it is straightforward to connect circuitry from the circuit board 24 to components held within the inner casing 20 since conductive pathways can pass through the open side 21. The upper edges of the inner casing 20 are in this example provided with protruding lugs 22, which extend around the sides of the inner casing 20. These lugs 22 provide a snap-fit with corresponding recesses 32 on an outer bezel 30 as explained further below.

It should be understood that the lugs 22 and recesses 32 are simply one example of how one might achieve the required interconnections between the inner casing 20 and the outer bezel 30. It would be possible to alternatively have lugs on the outer bezel 30 and recesses on the inner casing 20, or indeed different mechanical arrangements could be used to achieve a suitable snap-fit connection. Couplings known in relation to surface mount technology could be used, or alternatively the connection between the inner casing 20 and the bezel 30 could involve the use of an adhesive or other bonding method.

FIG. 6 shows the inner casing 20 mounted to a flexible printed circuit board assembly 24 and ready to receive a fingerprint sensor 26 and also a protective layer 28. These are inserted through the open top of the inner casing 20 and then connected to circuitry on the flexible circuit board in an appropriate fashion for example by the use of surface mount technology, soldering, or conductive adhesive. The three walls of the inner case 20 are slightly taller than the height of the fingerprint sensor 26 together with the protective layer 28, and this height difference is exaggerated in the Figures. The fingerprint sensor 26 can be an area fingerprint sensor 26 of any suitable type. The protective layer 28 can be any suitably thin scratch resistant material that is compatible with the fingerprint sensor 26 such as, for example chemically toughened glass. One possible material is alkali-aluminosilicate sheet glass, such as the glass sold under the trade name Gorilla Glass® and manufactured by Corning Inc. of New York, USA. This type of glass is commonly used as a cover glass for touch screens on mobile devices such as smartphones and other similar cover glass products could be used for the protective layer 28. The protective layer 28 is about 400 μm thick, which means that it can be added on top of suitable a fingerprint sensor 26 without adversely affecting the total width of the fingerprint sensor assembly 130, and in particular whilst allowing the smartcard 102 with the fingerprint sensor assembly 130 to meet the thickness restrictions of ISO 7816.

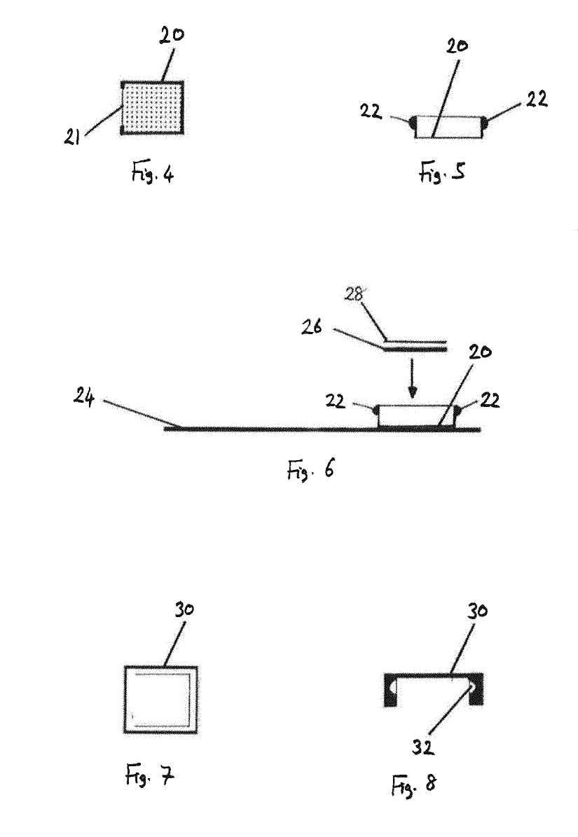

As noted above an outer bezel 30 is mounted to the inner case 20. The outer bezel 30 is shown in plan view in FIG. 7 and in side/sectional view in FIG. 8. It has four side walls forming an open frame with the sides of the frame having an inverted, L-shape section in order that the bezel 30 surrounds the sides of the fingerprint sensor 26 and the protective layer 28 and also extends across and frames the top of the fingerprint sensor 26 and the protective layer 28. This means that the bezel 30 can act to hold the fingerprint sensor 26 and the protective layer 28 in place, including holding the protective layer 28 firmly against the fingerprint sensor 26. Moreover, in most cases the bezel 30 is made from a conductive material and hence provides the required conductive field for proper functionality of the fingerprint sensor 26 in terms of capturing the fingerprint stop the presence of a conductive outer element is a requirement for many types of fingerprint sensor. In the case that the bezel 30 is used as a conductive element then the inner casing 20 can also be made of a conductive material allowing for an electrical connection via the inner casing 20 to the circuit on the circuit board 24. The inner casing 20 can be connected to the circuit board 24 by soldering or via conductive adhesive, for example, in order to both bond the inner casing 20 to the circuit board 24 as well as electrically connecting the inner casing 20 to the circuit which is formed on the circuit board 24.

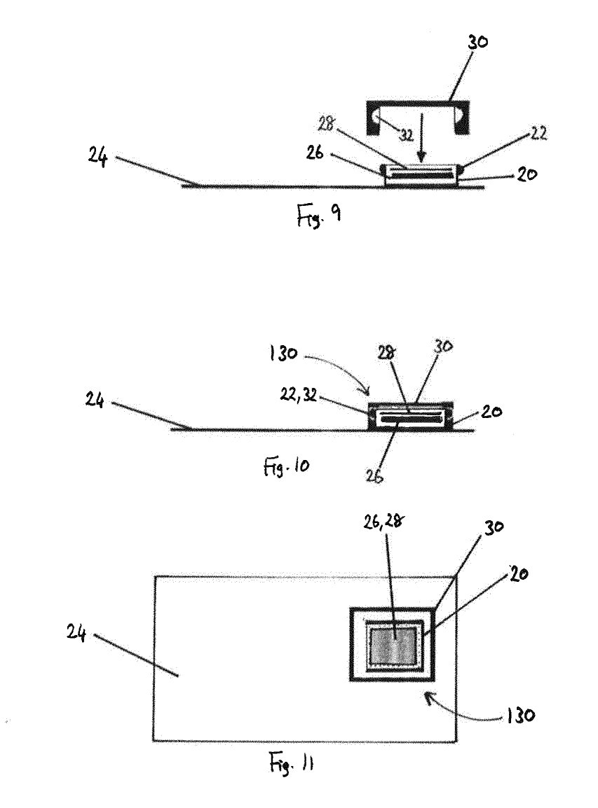

The bezel 30 is fitted to the inner casing 20 as shown in FIGS. 9 and 10, in this example this is done with a snap-fit utilising the lugs 22 and corresponding recesses 32. The use of a snap-fit connection, or similar mechanical connection, means that the bezel 30 can be simply pushed into place, whilst the fingerprint sensor 26 and protective layer 28 are already held within the inner casing 20, such that it is simple to both secure the fingerprint sensor 26 and protective layer 28 to the inner casing 20, and to complete the fingerprint sensor assembly 130 by providing a suitable electrically conductive bezel 30, if required, about the fingerprint sensor 26. Moreover, by the use of a two-part bezel assembly made up of the inner casing 20 and the outer bezel 30 then the fingerprint sensor assembly 130 is provided with reinforcement and is well protected from torsional forces that might otherwise be passed to the fingerprint sensor 26 and/or the protective layer 28, which can be relatively fragile in terms of bending and torsion forces. This is particularly helpful in the case of the examples where the fingerprint sensor assembly is used on a smartcard 102, especially with a laminated card as shown in FIG. 3. However, the advantages arising from the use of the fingerprint sensor assembly 130 and assembly method described above are also beneficial in other contexts where a fingerprint sensor is used for a biometric league authorised device, for example a control token such as a vehicle keyless entry fob.

FIG. 12 shows a further example of a smartcard 102 with a laminated card body 140, which may be similar to the smartcard 102 of FIG. 3, but has the fingerprint sensor assembly 130 and the electrocardiograph electrode 142 in different positions. The Figure also illustrates the use of the smartcard 102 for obtaining an electrocardiograph signal between the user's two thumbs. It is notable that with the same positioning of the user's hands the smartcard 102 can also be used to check for a match from the user's right thumbprint due to location of the right thumb on the fingerprint sensor assembly 130.

Suitable methods for manufacturing various aspects of an electronic card of the type described herein are set forth, for example, in WO2013/160011, U.S. 62/262,944, U.S. 62/262,943, U.S. 62/312,773, U.S. 62/312,775 and U.S. 62/312,803.

1. A fingerprint authorisable device comprising:
a fingerprint sensor assembly including a fingerprint sensor and a conductive bezel;
a control system for controlling the device by providing access to one or more functions of the device in response to identification of an authorised user; and
an electrocardiograph electrode;
wherein the electrocardiograph electrode and the conductive bezel of the fingerprint sensor assembly are arranged for use as two electrodes for obtaining an electrocardiograph signal between two hands of the user; and
wherein the control system is arranged to provide access to one or more functions of the device based on fingerprint data from the fingerprint sensor and/or based on the electrocardiograph signal.

2. A fingerprint authorisable device as claimed in claim 1, wherein the control system is arranged such that an electrocardiograph signal match is required as well as a fingerprint match in order for full access to be provided to the one or more functions of the device.

3. A fingerprint authorisable device as claimed in claim 1, wherein the control system is arranged to prevent access to some or all of the one or more functions of the device when the electrocardiograph signal indicates that the finger is a false finger and/or a non-living finger.

4. A fingerprint authorisable device as claimed in claim 1, wherein the conductive bezel is electrically connected to the device such that it can act to provide an electrical field for detecting the fingerprint using an active capacitance sensor as the fingerprint sensor.

5. A fingerprint authorisable device as claimed in claim 4, wherein the device includes only one electrocardiograph electrode in addition to the conductive bezel.

6. A fingerprint authorisable device as claimed in claim 1, wherein the control system is arranged to use the electrocardiograph signal to identify an authorised user without the use of fingerprint data.

7. A fingerprint authorisable device as claimed in claim 1, wherein the control system is arranged such that in the event of at least one of: electrocardiograph authorisation without fingerprint authorisation being used to access the one or more functions of the device, and fingerprint authorisation without electrocardiograph authorisation being used to access the one or more functions of the device; then the user is permitted access to different or fewer functions than are accessible in the case of using both of electrocardiograph and fingerprint authorisation.

8. A fingerprint authorisable device as claimed in claim 1, wherein the fingerprint sensor is secured to the fingerprint authorisable device by the conductive bezel, which hence forms an enclosure of the fingerprint sensor assembly or a part of an enclosure of the fingerprint sensor assembly.

9. A fingerprint authorisable device as claimed in claim 4, wherein the fingerprint sensor is secured to the fingerprint authorisable device by the conductive bezel, which hence forms an enclosure of the fingerprint sensor assembly or a part of an enclosure of the fingerprint sensor assembly.

10. A fingerprint authorisable device as claimed in claim 9, wherein the conductive bezel encloses some or all of the outer periphery of the fingerprint sensor and a part of the conductive bezel extends across an outer rim of the exposed surface of the fingerprint sensor.

11. A fingerprint authorisable device as claimed in claim 1, comprising a flexible electronic circuit incorporating the fingerprint sensor, the electrocardiograph electrode and the control system.

12. A fingerprint authorisable device as claimed in claim 11, comprising an antenna for wireless communication, for example using RF communication.

13. A fingerprint authorisable device as claimed in claim 1, wherein the control system is arranged to enroll an authorised user by obtaining fingerprint data via the fingerprint sensor and by obtaining electrocardiograph data via the electrocardiograph electrode/conductive bezel.

14. A fingerprint authorisable device as claimed in claim 1, wherein the fingerprint authorisable device is a smartcard such as any of: an access card; a credit card; a debit card; a pre-pay card; a loyalty card; an identity card; and a cryptographic card.

15. A fingerprint authorisable device as claimed in claim 1, wherein the fingerprint authorisable device is a smartcard such as any of: an access card; a credit card; a debit card; a pre-pay card; a loyalty card; an identity card; and a cryptographic card.

16. A fingerprint authorisable device as claimed in claim 1, wherein the fingerprint authorisable device is a control token such as a keyless entry key for a vehicle.

17. A method of controlling a fingerprint authorisable device comprising: a fingerprint sensor assembly including a fingerprint sensor and a conductive bezel; a control system for controlling the device; and an electrocardiograph electrode; the method including:
one or both of using the electrocardiograph electrode and the conductive bezel of the fingerprint sensor assembly as two electrodes for obtaining an electrocardiograph signal between two hands of the user, and using the fingerprint sensor for obtaining fingerprint data from the user; and
providing access to one or more functions of the device based on the fingerprint data from the fingerprint sensor and/or based on the electrocardiograph signal.

18. A method as claimed in claim 17, comprising using the electrocardiograph electrode and the conductive bezel of the fingerprint sensor assembly as two electrodes for obtaining an electrocardiograph signal between two hands of the user; determining if the owner of the finger is not alive, or the finger has been amputated based on the electrocardiograph signal; and rejecting the authorisation attempt when the electrocardiograph signal indicates that the finger is a false and/or a non-living finger.

19. A method as claimed in claim 17 comprising using a device as claimed in claim 1.

20. A method of manufacturing a fingerprint authorisable device comprising:
providing a control system for controlling the device, wherein the control system is arranged to provide access to one or more functions of the device in response to identification of an authorised user;
providing a fingerprint sensor assembly including a fingerprint sensor for obtaining fingerprint data; providing the fingerprint sensor assembly with a conductive bezel;
and providing an electrocardiograph electrode on the device;
wherein the conductive bezel and the electrocardiograph electrode are for obtaining an electrocardiograph signal from between two hands of a user; and
wherein the control system is arranged to provide access to one or more functions of the device based on the fingerprint data from the fingerprint sensor and/or based on the electrocardiograph signal.
